(19) United States
(12) Patent Application Publication
(10) Pub. No.: US 2006/0263677 A1
(43) Pub. Date: Nov. 23, 2006

(54) Battery seat having two positive terminals

(76) Inventor: Chou Hsuan Tsai, Hsin-Chuang City (TW)

Correspondence Address: PRO-TECHTOR INTERNATIONAL SERVICES, 20775 NORADA CT., SARATOGA, CA, 95070, US

(21) Appl. No.: 11/435,404

(22) Filed: May 16, 2006

(30) Foreign Application Priority Data
May 17, 2005 (TW) 094207968

(51) Int. Cl. H01M 2/10

(52) U.S. Cl. 429/97; 429/100

(57) ABSTRACT

A battery seat includes a base and terminals. The base has a circumferential wall and a placement surface, which define a placement slot to prevent a battery placed in the placement slot from separating from the wall. The wall is formed with an opening into which a finger may insert, and a first engagement portion for engaging with the battery. The first engagement portion is formed with inner and outer guiding slants for guiding in/out the battery. Each terminal has an elastic arm disposed in the placement slot and electrically connected to the battery, a positioning portion for positioning the base, and a pin portion extending out of the base. The terminals comprise two positive terminals and one negative terminal. The elastic arms of the positive terminals extend out of an inner surface of the circumferential wall. The elastic arm of the negative terminal extends out of the placement surface.

### BACKGROUND OF THE INVENTION

1. Field of the Invention

The invention relates to an electrical connector, and more particularly to a battery seat to be connected to a button battery.

2. Description of the Related Art

A mainboard usually has a battery seat to be electrically connected to a battery for providing power to electrical elements mounted thereon. The conventional battery seats may be found in Taiwan Patent Publication Nos. TW318609, TW318610, TW391568 and TW435833.

Because the electrical product is gradually minimized, the battery seat has to be disposed on the mainboard in an upright manner in order to save the area occupied by the battery seat on the mainboard.

TW435833 is the commonly assigned patent and discloses a battery seat that may be easily used. The battery seat has an upright pattern and the structure thereof is illustrated in FIGS. 4 to 7 of TW435833 patent. The battery seat has a base 1, a positive terminal 2 and a negative terminal 3. The base 1 has a circumferential wall 11 for defining a placement slot 12 such that the battery 95 placed therein cannot escape from the circumferential wall. The circumferential wall 11 has an opening 13 into which a finger may insert, and two first engagement portions 14 and one second engagement portion 15 for engaging with the battery 95 placed in the placement slot. The first engagement portions 14 are formed with inner and outer guiding slants 141 and 142 for guiding in/out the battery. In use, as shown in FIG. 5 of TW435833 patent, one end of the battery 95 is directly inserted into the placement slot 12 and is then engaged by the second engagement portion 15. Then, the battery 95 is laterally pressed. The other end of the battery is engaged by the first engagement portion 14, as shown in FIG. 6 of TW435833 patent. When the battery 95 is to be taken out, the finger inserts into the opening 13 and pushes the battery outwards. As shown in FIG. 10 of TW435833 patent, the contact 21 of the positive terminal is positioned on the inner surface of the circumferential wall. Such a design has the mistake-proof effect. That is, when the battery is incorrectly installed, the positive connection point of the battery contacts the positive terminal 2 and the negative terminal 3, and no power of the battery will be outputted because the face side and the circumference of the battery are the positive connection point, and the bottom surface of the battery is the negative connection point.

However, the prior art still has some drawbacks.

First, as shown in FIG. 7 of TW435833 patent, the positive terminal 2 has two pins 23 separated from each other by a gap, so the positive terminal has to be made by pressing a wider plate and the material is thus wasted because the mainboard has three holes for mating with an upright battery seat that is inserted.

Second, as shown in FIG. 10 of TW435833 patent, the mistake-proof design functions as the contact 21 of the positive terminal 2 is located on the inner surface of the circumferential wall. At this time, the battery 95 contacts the positive terminal 2 at only one point on a lateral side. So, the contact is not very reliable.

Third, the seat is bonded to the circuit board through three pins. The fixing effect is not quite good, and the seat may not withstand the lateral pushing force.

### SUMMARY OF THE INVENTION

It is therefore an object of the invention to provide a battery seat having two positive terminals to save the material in the manufacturing process and to enhance the reliable electrical connection effect by two contact points.

Another object of the invention is to provide a battery seat having at least one board-engaging element formed with an elastic hook for hooking a hole of a to-be-connected circuit board, thereby enhancing the combination intensity with the mainboard.

To achieve the above-mentioned objects, the invention provides a battery seat including a base and a plurality of terminals. The base has a circumferential wall and a placement surface, which define a placement slot to prevent a battery placed in the placement slot from separating from the circumferential wall. The circumferential wall is formed with an opening into which a finger may insert, and at least one first engagement portion for engaging with the battery placed in the placement slot. The at least one first engagement portion is formed with inner and outer guiding slants for guiding in/out the battery. Each of the terminals has an elastic arm disposed in the placement slot and electrically connected to the battery, a positioning portion for positioning the base, and a pin portion extending out of the base. The terminals comprise two positive terminals and one negative terminal. The elastic arms of the positive terminals extend out of an inner surface of the circumferential wall. The elastic arm of the negative terminal extends out of the placement surface.

The base may have at least one board-engaging element formed with an elastic hook for hooking a hole of a to-be-connected circuit board.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a pictorially exploded view showing a first embodiment of the invention.

FIG. 2 is a pictorially assembled view showing the first embodiment of the invention.

FIGS. 3 and 4 are side views showing a usage state of the first embodiment of the invention.

FIG. 5 is a pictorial view showing the usage state of the first embodiment of the invention.

FIG. 6 is a side view showing the usage state of the first embodiment of the invention.

FIG. 7 is a pictorially exploded view showing a second embodiment of the invention.

FIG. 8 is a pictorially assembled view showing the second embodiment of the invention.

FIG. 9 is a pictorial view showing a third embodiment of the invention.

FIG. 10 is a pictorial view showing a fourth embodiment of the invention.

### DETAILED DESCRIPTION OF THE INVENTION

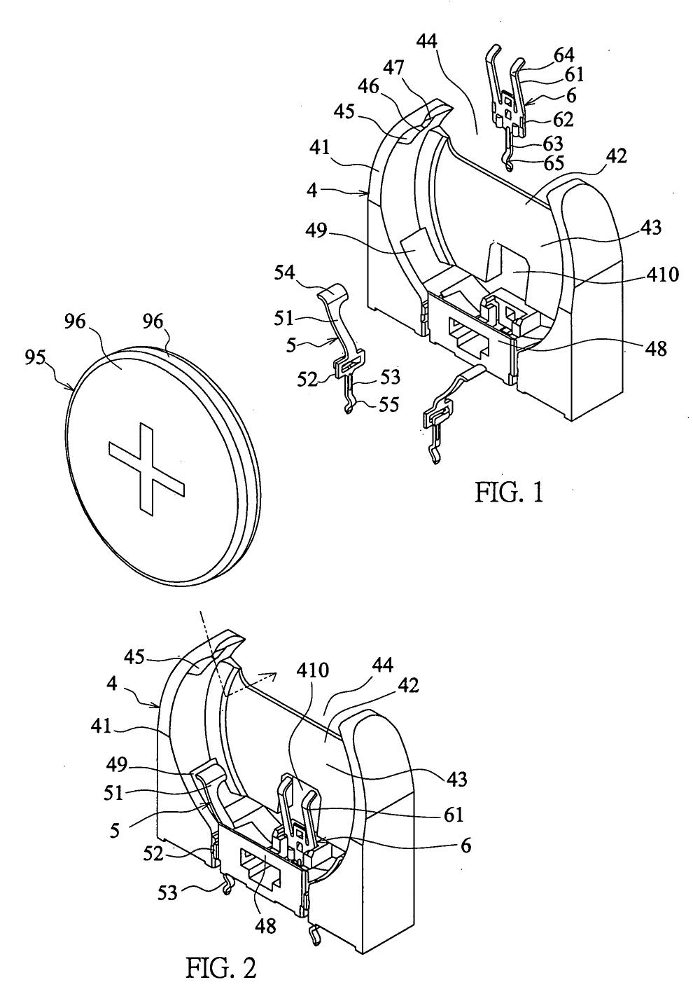

Referring to FIGS. 1 to 3, a battery seat of the invention includes a base 4, two positive terminals 5 and one negative terminal 6. The base 4 stands upright and has an arced circumferential wall 41 and a placement surface 42, which define a placement slot 43 to prevent the battery 95 placed in the placement slot 43 from separating from the circumferential wall 41. The placement surface 42 is an inclined surface. The topmost end of the circumferential wall 41 is formed with an opening 44 into which a finger may insert. The opening 44 occupies about a ¼ circle. The placement surface 42 is formed with a notch corresponding to the opening 44 and is slightly lower than the circumferential wall 41. Two sides of the circumferential wall 41 near the opening 44 are formed with first engagement portions 45 engaging with a top end of the battery placed in the placement slot 43. The first engagement portion 45 has inner and outer guiding slants 46 and 47 for guiding in/out the battery. A second engagement portion 48 for engaging with a bottom end of the battery placed in the placement slot 43 is formed on the circumferential wall 41 at one side corresponding to the first engagement portion 45. The inner surface of the circumferential wall 41 is formed with two slots 49 at two sides of the second engagement portion 48. The placement surface 42 also has one slot 410.

The positive terminal 5 has an elastic arm 51, a positioning portion 52 and a pin portion 53. The elastic arm 51 is located within the placement slot 43, and has a projecting contact 54 near a distal end thereof. The positioning portion 52 positions the base 4. The pin portion 53 extends vertically out of the base 4 and is formed with an elastic hook 55 at a bottom end thereof. The elastic hook 55 hooks a hole of a to-be-connected circuit board. The elastic arms 51 of the positive terminals project out of the inner surface of the circumferential wall 41 and extend in opposite directions toward the inner surface of the circumferential wall. The elastic arms 51 of the positive terminals may be moved elastically in the slots 49, respectively.

The negative terminal 6 has an elastic arm 61, a positioning portion 62 and a pin portion 63. The elastic arm 61 is located in the placement slot 43 and has a projecting contact 64 near a distal end thereof. The positioning portion 62 positions the base 4. The pin portion 63 extends vertically out of the base 4 and is formed with an elastic hook 65 at a bottom end thereof. The elastic hook 65 engages with the hole of the to-be-connected circuit board. The elastic arm 61 projects over the placement surface 42 and may be elastically moved in the slot 410.

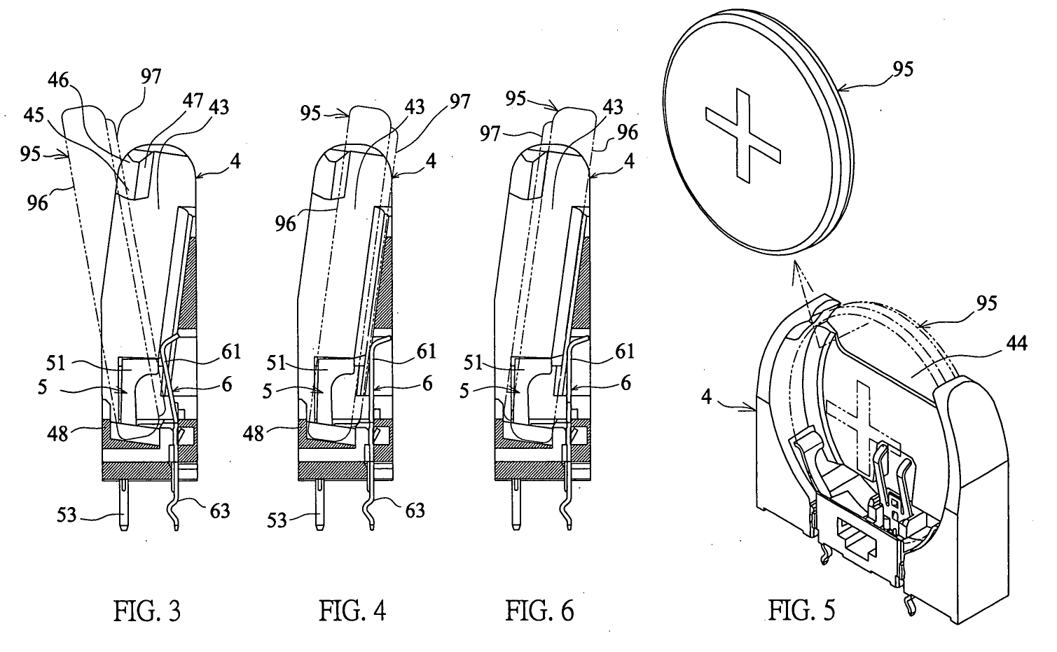

According to the above-mentioned structure, as shown in FIG. 3, one end of the battery 95 is fit into the placement slot 43 and engaged with the second engagement portion 48, and then the battery 95 is pressed into the slot 43 laterally. The other end of the battery 95 is engaged with the two first engagement portions 45, as shown in FIG. 4. At this time, the positive connection point at the circumferential side of the battery contacts the elastic arms 51 of the two symmetrical positive terminals 5, and the negative connection point 97 on the bottom surface of the battery contacts the elastic arm 61 of the negative terminal 6. As shown in FIG. 5, the finger may insert into the opening 44 to push the battery 95 outwards in order to take out the battery 95.

As shown in FIG. 6, this embodiment has the mistake-proof design. When the battery 95 is incorrectly installed (i.e., the face side faces the placement slot 43), the positive connection point 96 of the face side of the battery contacts the elastic arm 61 of the negative terminal 6, and the positive connection point on the circumferential side of the battery contacts the elastic arm 51 of the positive terminal 5. Because the negative connection point 97 of the battery does not contact any terminal, no power of the battery is outputted such that the mistake-proof effect may be achieved.

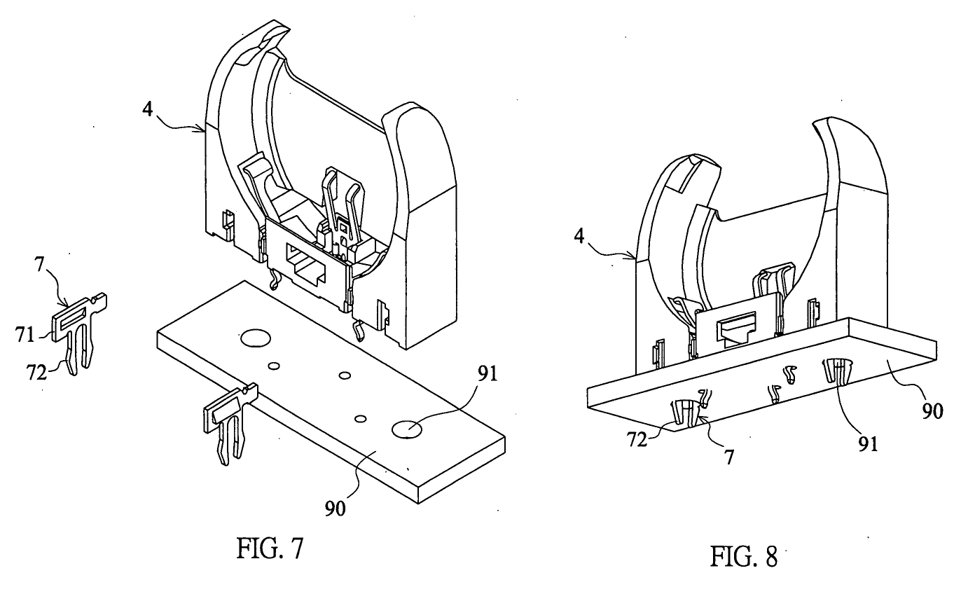

As shown in FIGS. 7 and 8, the second embodiment of the invention is almost the same as the first embodiment except that the base 4 of this embodiment is formed with two board-engaging elements 7 each having a positioning portion 71 and two elastic hooks 72 for hooking the hole 91 of the to-be-connected circuit board 90.

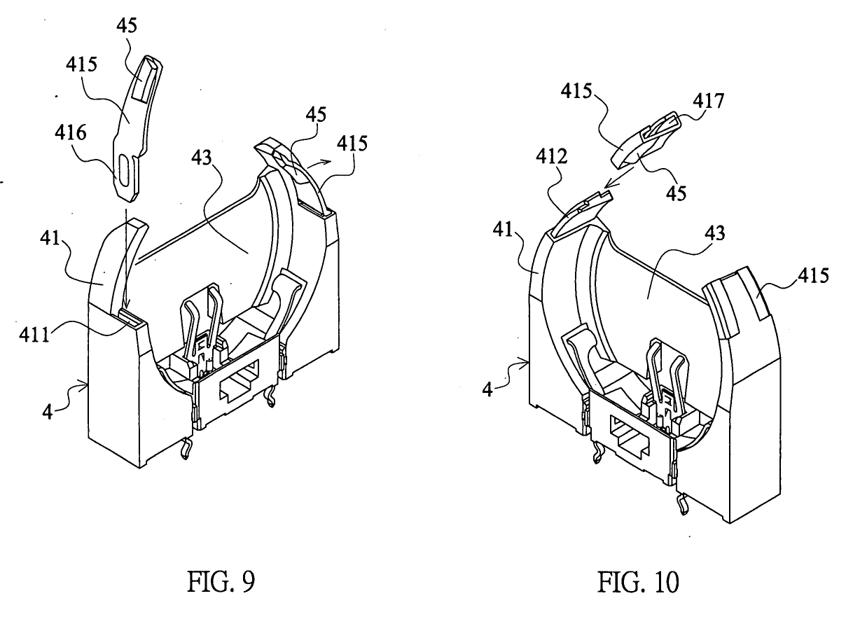

As shown in FIG. 9, the third embodiment is almost the same as the first embodiment except that two sides of the circumferential wall 41 of the base 4 of the third embodiment are combined with engaging members 415 made of a metal material. Each engaging member 415 is integrally formed with a first engagement portion 45 formed with inner and outer guiding slants for guiding in/out the battery. The circumferential wall 41 is formed with two slots 411 at two sides, and the engaging member 415 has an arc shape and is formed with a fitting board 416 at a bottom end thereof to fit with the slot 411.

As shown in FIG. 10, the fourth embodiment of the invention is almost the same as the third embodiment except that each engaging member 415 of the fourth embodiment has a fitting slot 417, and the two sides of the circumferential wall 41 of the base 4 are formed with fitting boards 412 to be fit with the fitting slots 417 of the engaging members 415.

Thus, the invention has the following advantages.

First, the invention has two positive terminals to save the material in the manufacturing process and to achieve the reliable electrical connection effect by two contact points.

Second, the invention has the board-engaging element formed with the elastic hook for hooking the hole of the to-be-connected circuit board, thereby enhancing the combining intensity with the mainboard.

Third, the invention has the mistake-proof effect to prevent the incorrectly installed battery from causing poor signals to interfere the mainboard.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A battery seat, comprising:
a base having a circumferential wall and a placement surface, which define a placement slot to prevent a battery placed in the placement slot from separating from the circumferential wall, wherein the circumferential wall is formed with an opening into which a finger may insert, and at least one first engagement portion for engaging with the battery placed in the placement slot, and the at least one first engagement portion is formed with inner and outer guiding slants for guiding in/out the battery; and
a plurality of terminals, each of which has an elastic arm disposed in the placement slot and electrically connected to the battery, a positioning portion for positioning the base, and a pin portion extending out of the base, wherein:
the terminals comprise two positive terminals and one negative terminal;
the elastic arms of the positive terminals extend out of an inner surface of the circumferential wall; and
the elastic arm of the negative terminal extends out of the placement surface.

2. The battery seat according to claim 1, wherein the elastic arms of the two positive terminals extend in opposite directions toward the inner surface of the circumferential wall.

3. The battery seat according to claim 1, wherein the inner surface of the circumferential wall of the base is formed with two slots and the elastic arms of the positive terminals may be elastically moved in the slots, respectively.

4. The battery seat according to claim 1, wherein the placement surface of the base is formed with a slot, and the elastic arm of the negative terminal may be elastically moved in the slot.

5. The battery seat according to claim 1, wherein the placement surface of the base is an inclined surface.

6. The battery seat according to claim 1, wherein at least one second engagement portion for engaging with the battery placed in the placement slot is formed on the circumferential wall of the base at a side corresponding to the at least one first engagement portion.

7. The battery seat according to claim 1, wherein the base has at least one board-engaging element formed with a hook for hooking a hole of a to-be-connected circuit board.

8. The battery seat according to claim 1, wherein the pin portion of the positive terminal is formed with an elastic hook for hooking a hole of a to-be-connected circuit board.

9. The battery seat according to claim 1, wherein the pin portion of the negative terminal is formed with an elastic hook for hooking a hole of a to-be-connected circuit board.

10. The battery seat according to claim 1, wherein the circumferential wall is assembled with at least one engaging member, which is integrally formed with the at least one first engagement portion.

11. The battery seat according to claim 10, wherein the at least one engaging member is made of a metal material.

12. A battery seat, comprising:
a base having a circumferential wall and a placement surface, which define a placement slot to prevent a battery placed in the placement slot from separating from the circumferential wall, wherein the circumferential wall is formed with an opening into which a finger may insert, and at least one first engagement portion for engaging with the battery placed in the placement slot, and the at least one first engagement portion is formed with inner and outer guiding slants for guiding in/out the battery; and
a plurality of terminals, each of which has an elastic arm disposed in the placement slot and electrically connected to the battery, a positioning portion for positioning the base, and a pin portion extending out of the base, wherein the base has at least one board-engaging element, which is formed with an elastic hook for hooking a hole of a to-be-connected circuit board.

13. The battery seat according to claim 12, wherein the placement surface of the base is an inclined surface.

14. The battery seat according to claim 12, wherein the pin portion of at least one of the terminals is formed with an elastic hook for hooking the hole of the to-be-connected circuit board.

15. The battery seat according to claim 12, wherein at least one second engagement portion for engaging with the battery placed in the placement slot is formed on the circumferential wall of the base at a side corresponding to the at least one first engagement portion.
